(19) United States
(12) Patent Application Publication
(10) Pub. No.: US 2001/0009036 A1
(43) Pub. Date: Jul. 19, 2001

(54) Method, recording medium, computer and controller for changing the settings various parameters of electronic equipment

(76) Inventor: Nobuhiro Komata, Tokyo (JP)

Correspondence Address: HELFGOTT & KARAS, P.C., 60th FLOOR, EMPIRE STATE BUILDING, NEW YORK, NY, 10118-0110, US

(21) Appl. No.: 09/758,102

(22) Filed: Jan. 10, 2001

(30) Foreign Application Priority Data
Jan. 14, 2000 (JP) 2000-40272

(51) Int. Cl. H04N 7/173; H04N 7/16

(52) U.S. Cl. 725/133; 725/141

(57) ABSTRACT

To improve a user interface in using electronic equipment, a computer has a controller which has pressure-sensitive unit to sense a pushing pressure applied by the user of the controller to generate a pressure-sensing signal. A unit for changing the settings of various parameters in the electronic equipment is connected to the pressure-sensitive unit to change those parameters according to the pressure-sensing signal. A unit for vibrating a vibration generator of the controller in accordance with the changes in settings of various parameters is provided to transmit a “click” sensation to the user to let the user know of the changes.

### FIELD OF THE INVENTION

The present invention relates to a computer, a method using the computer for changing the settings of various parameters, also a recording medium, and a controller used by the computer.

### BACKGROUND OF THE INVENTION

In the case of changing the values of parameters of electronic equipment, for example, typically a button is pushed or held down by a user of the electronic equipment the same number of times as the parameter of the electronic equipment is to be incremented.

On the other hand, the so-called pressure-sensitive type controllers are used as input devices for electronic equipment represented by computers, and as input devices for entertainment systems represented by game machines, for example. A pressure-sensitive controller is a unit wherein, when pressure is applied with a finger of a user directly to a control element connected to a pressure-sensitive device, the pushing pressure is provided as output as a pressure-sensing value. A specific example thereof is, for example, a pressure-sensitive type controller disclosed in the publication of examined Japanese utility model application No. JP-B-H1-40545, wherein pressure-sensitive output is provided as input to a VCO (variable control oscillator) and the output of the VCO is used for repeated fire in a game.

### SUMMARY OF THE INVENTION

It is an object of the present invention to provide a method and a computer which in the case of changing the values of parameters, where the situation of incrementing is conventionally presented only visually, improves the user's interface even further.

This and other objects of the present invention are attained by a recording medium on which is recorded a computer-readable and executable software program that performs processing by taking as instructions an output from a controller which has pressure-sensitive means, wherein the software program comprises a processing program that changes settings at a rate depending on the output of said controller.

In a recording medium according to the present invention on which is recorded a computer-readable and executable software program that performs processing by taking as instructions the output from a controller which has pressure-sensitive means and vibration means, the software program comprises a processing program that vibrates said vibration means at a rate depending on the output of the controller.

In an embodiment a recording medium according to the present invention or which is recorded a computer-readable and executable software program that performs processing by taking as instructions the output from a controller which has pressure-sensitive means and vibration means, the software program comprises a processing program that changes settings at a rate depending on the output of the controller, and also, at least vibrates the vibration means.

A computer according to the present invention comprises a controller which has pressure-sensitive means; means for sensing a pushing pressure of a user on a control element of the computer by said pressure-sensitive means to generate a pressure-sensing signal; and

means for changing settings of various parameters of the computer in accordance with said pressure-sensing signal.

A computer according to the present invention comprises a controller which has pressure-sensitive means and vibration means, comprising: means for sensing a pushing pressure by said pressure-sensitive means to generate a pressure-sensing signal, means for changing the settings of various parameters corresponding to said pressure-sensing signal; and means for vibrating said vibration means corresponding to said changes in settings of various parameters.

A method of using a computer according to the present invention comprises the steps of using a computer having a controller including pressure-sensitive means; sensing a pushing pressure of a user on the controller of the computer by said pressure-sensitive means to generate a pressure-sensing signal; and changing settings of various parameters of the computer in accordance with said pressure-sensing signal.

Moreover, a method of using a computer according to the present invention comprises the steps of using a computer having a controller which has pressure-sensitive means and vibration means; sensing a pushing pressure applied by a user on said controller, by said pressure-sensitive means to generate a pressure-sensing signal; changing settings of various parameters of the computer in accordance with said pressure-sensing signal, and vibrating said vibration means in accordance with said pressure-sensing signal.

A controller according to the present invention is connected to a computer and gives instructions to said computer, and comprises pressure-sensitive means that senses a pushing pressure applied by a user on the controller and provides a pressure-sensing signal as output to said computer; and vibration means that transmits vibration to the user, and which, when an adjustment of various parameters is performed in accordance with said pressure-sensing signal, vibrates said vibration means according to said adjustment.

### BRIEF DESCRIPTION OF THE DRAWINGS

FIG. 1 is a schematic diagram of connection of a controller to an entertainment system in order to enable a user of the entertainment system to enjoy game software or videos;

FIG. 2 is a diagram showing an example of a screen display known as a “CONFIG screen” for setting various parameters at the time of execution of software;

FIG. 3 is a table for selecting the ratio of stepping according to respective pressure-sensing values obtained in the controller;

FIG. 4 is a flowchart of the processing of a parameter setting program including a program for incrementing the value of a parameter at a rate depending on the pressure-sensing value, and also, generating with vibration a “click” sensation that matches the incrementing;

FIG. 5 is a perspective view of the controller connected to the entertainment system;

FIG. 6 is a block diagram showing the overall entertainment system;

FIG. 7 is a top view of the controller;

FIG. 8 is an exploded perspective view showing the configuration of the second control part of the controller;

FIGS. 9A-9C are cross-sectional views of the second control part of the controller of FIG. 8;

FIG. 10 is a diagram showing an equivalent circuit for a pressure-sensitive device consisting of a resistor and conducting member;

FIG. 11 is a block diagram of the main parts of the controller;

FIG. 12 is an exploded perspective view showing the constitution of the first control part of the controller;

FIG. 13 is a cross-sectional view of the first control part of FIG. 12;

FIG. 14 is a diagram showing a circuit configuration of a resistor;

FIG. 15 is a graph showing the characteristics of the analog signal (voltage) outputted from the output terminal of the resistor;

FIG. 16 is a block diagram showing an embodiment in which the analog signal (voltage) outputted from the resistor is provided as an input to an A/D converter;

FIG. 17 is an exploded perspective view showing the configuration of the third control part of the controller;

FIG. 18 is a perspective view showing a vibration generation system mechanism disposed on base sides of the first and second handle parts of the controller;

FIG. 19 is an exploded perspective view of a vibration generation system mechanism;

FIG. 20 is a perspective view of the vibration generation system mechanism, consisting of a motor with an eccentric member attached to a driveshaft; and

FIG. 21 is a side view for explaining the situation in which vibrations of the motor are transmitted via the side walls to the handle parts, to transmit vibrations to the fingers of a user.

### DETAILED DESCRIPTION OF THE PREFERRED EMBODIMENTS

In a controller that uses a pressure-sensitive device, when the button which is the control element is pushed by a user, not only is the presence of a pressure-sensing output detected, for example, as the ON/OFF of a switch, but also a pressure-sensing value output which depends on the pushing pressure is also obtained. On the other hand, in software or games that use pressure-sensing value output, various processing or actions can be entered depending on the pressure-sensing value output. In this embodiment, even when setting parameter values by operating a control element, it is possible to change the parameter values depending on the pressure-sensing values based on the pushing operation of various control elements by the user, and moreover, it is possible for a “click” sensation which accompanies this change to be sensed bodily by the user.

In the present embodiment, parameter values are increased or decreased depending on pressure-sensing value output when a controller which has a pressure-sensitive device is operated, and also, a “click” sensation corresponding to the unit incrementing/decrementing of the value of the parameter. Thereby, it is possible to transmit to the user the sensation of incrementing a parameter by the pushing a pressure-sensitive switch, and thus the user interface with the entertainment system can be improved even further.

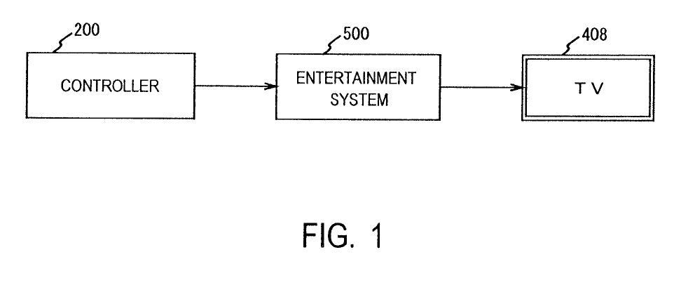

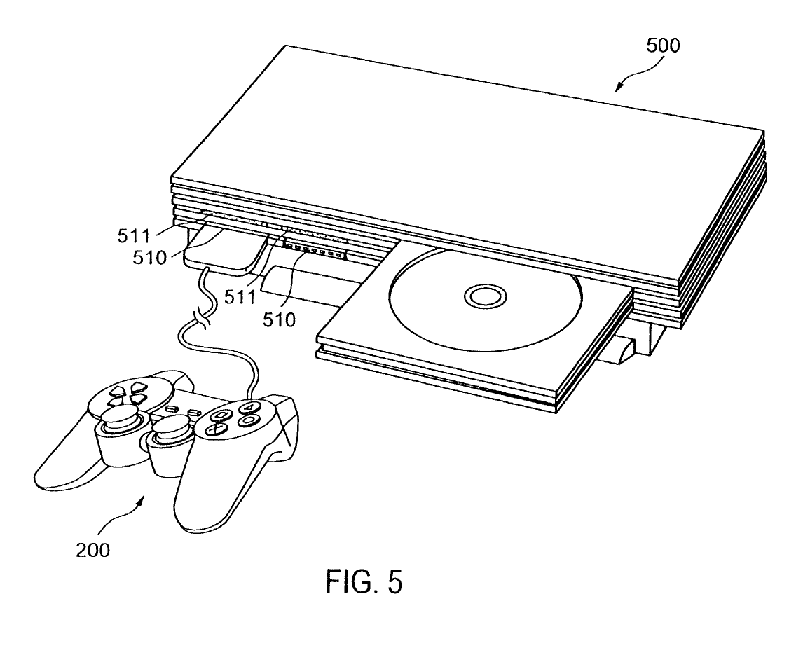

FIG. 1 shows connection of a controller to an entertainment system enable a user to enjoy game software or video. More specific examples are shown in FIG. 5 and the following figures.

As shown in this FIG. 1, a controller 200 which has buttons connected to pressure-sensitive devices and a vibration generator consisting of a motor and a rotating member attached to the shaft of the motor such that it is asymmetric to the center of the shaft is connected to an entertainment system 500 used for playing games or enjoying DVD video or other types of video images, and the video output terminals are connected to a television monitor 408.

Here, the analog output from the pressure-sensitive devices is converted by an A/D converter to digital values in the range 0-255 and provided to the entertainment system 500. In addition, based on a drive signal from the entertainment system 500, the aforementioned motor is driven and the aforementioned member rotates, so the vibration due to this rotation is transmitted to the player through the case of the controller. Note that the controller 200 equipped with a pressure-sensitive switch and vibration generator are to be described in detail later.

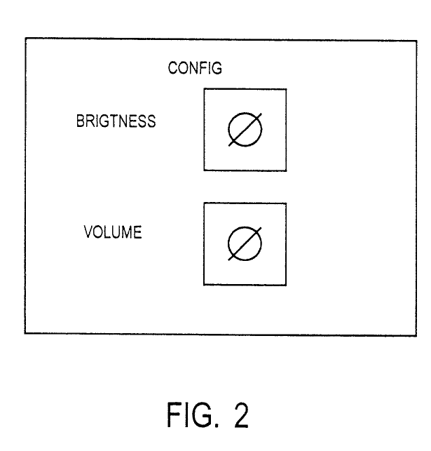

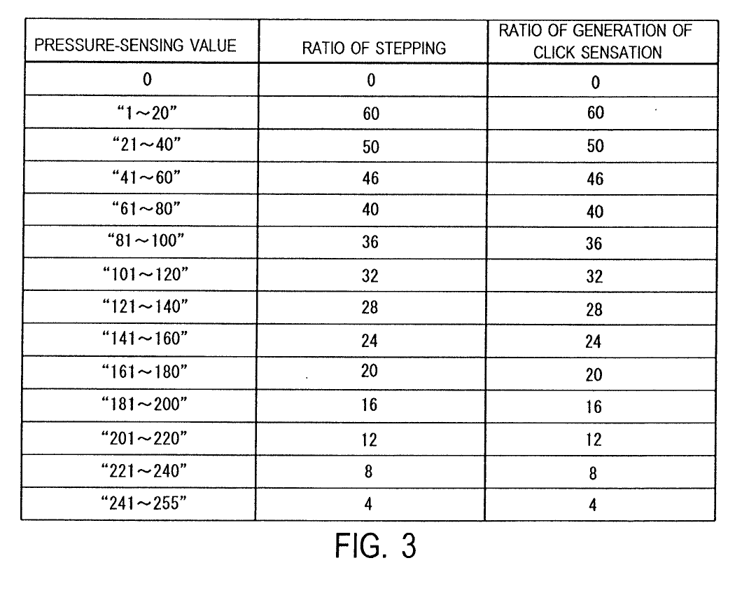

Here follows a description of the case of generating a “click” sensation by vibration at the time of operation of the controller 200, with reference to FIGS. 2 and 3.

FIG. 2 shows an example of a screen display known as a CONFIG (configuration) screen for setting various parameters at the time of execution of software, for example. This example is a CONFIG screen for setting the brightness of the monitor screen and the sound volume.

For example, previous software and the like had adopted a method whereby parameters are changed by repeatedly pushing an ON/OFF switch to increment or decrement the values of a parameter a single unit value or several unit values at a time. With this method, it is necessary to repeatedly push a button a number of times until the desired parameter is reached.

In this embodiment, this is changed so that the incrementing or decrementing of the value of a parameter is performed automatically at a rate depending on the magnitude of the pressure-sensing value from a pressure-sensitive controller, and moreover, a “click” sensation is generated in the controller or button to match its stepping.

FIG. 3 shows a table for selecting the ratio of stepping corresponding to the pressure-sensing values of “0”, “1-20”, . . . , “241-255” respectively. Note that the “ratio of generation of click sensation” is also presented as a reference, but this is not included in the table. The values presented in the table as the ratio of stepping each refers to a number of frames.

In addition, the “click” sensation is generated by the vibration generator of the controller 200. For example, the “click” sensation may be generated by rotating the vibration-generating member attached to the shaft of the motor a stipulated number of times at a stipulated speed. Here, the number of rotations is taken to be 3, for example. The sensation of one “click” is given by rotating three times at a stipulated strength. Thus, in order to give the sensation of three “clicks,” it is sufficient to rotate three times at the stipulated strength (for the first “click” sensation), and after a stipulated time K which may be the same time or longer, rotate three times at the stipulated strength (for the second “click” sensation), and again after a stipulated time K, rotate three times at the stipulated strength (for the third “click” sensation). The drive signal may be a signal of a magnitude to rotate the motor at the stipulated speed, and be of a duration sufficient for three rotations.

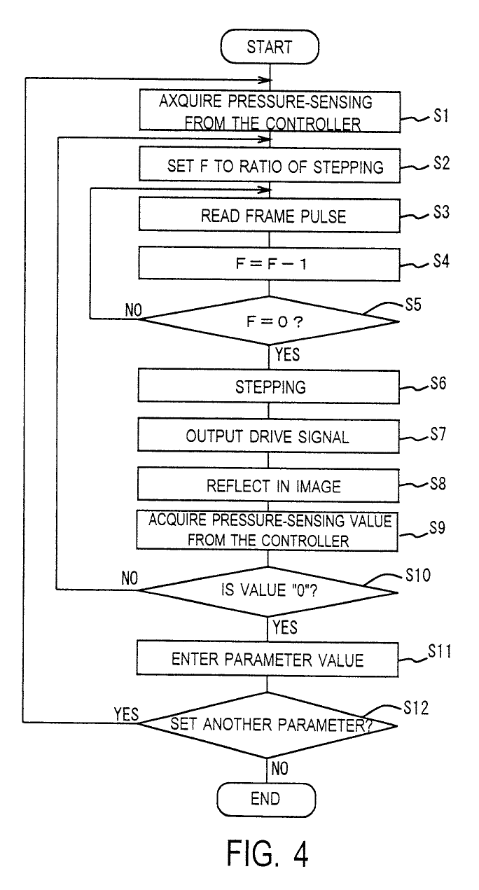

Next, in reference to FIG. 4, a parameter setting program will be described which includes a program for incrementing (decrementing is performed in the same manner) the value of a parameter depending on the pressure-sensing value and also generating with vibration a “click” sensation matching this incrementing. The flowchart in FIG. 4 shows the processing of a parameter setting program which includes a program for incrementing the value of a parameter depending on the pressure-sensing value and also generating with vibration a “click” sensation matching this incrementing.

In FIG. 4, in Step S1, the pressure-sensing value is acquired from the controller 200, and in Step S2, the variable F is set to the value of the ratio of stepping corresponding to the pressure-sense value. For example, if the pressure-sensing value is in the range “1-20” then a ratio of stepping of “60” is selected.

In Step S3, the frame pulse is read, and in Step S4, “1” is subtracted from the variable F.

In Step S5, a decision is made as to whether or not the variable F is “0” and if “YES” then control processing moves to Step S6, but if “NO” then control processing moves back to Step S3.

The processing from Step S3 to Step S5 is performed so that incrementing is performed at a rate selected depending on the pressure-sensing value, and thus the number of frames indicated by the selected ratio of stepping are counted, and after the count value reaches the number indicated by the selected ratio of stepping, the stepping of the value of the parameter in Steps S6 on is reflected in the screens, as when a screen showing “1” is changed to a screen showing “2” or the like, and for generating the “click” sensation.

In Step S6, stepping of the value of the parameter is performed, and in Step S7 a drive signal is output and thereby the motor is turned three times, generating a “click” sensation. Next, in Step S8, the stepping of the parameter is performed on the screen. In Step S9, a pressure-sensing value is acquired from the controller 200, and in Step S10 a decision is made as to whether or not it is “0,” and if “YES” then control processing moves to Step S11, but if “NO” then control processing moves back to Step S2.

The reason why the pressure-sensing value is acquired in Step S9 and the decision of whether or not this value is “0” is made in Step S10 is to detect when the user has finished pushing the pressure-sensitive switch, namely when his/her finger has released the pressure-sensitive switch, or has completely relaxed. Thus, in such a case, stepping must be halted.

In Step S11, the parameter value is entered. Note that it is possible to allocate a separate switch for giving the order to enter, so the parameter value need not be entered until such input is present. In this case, a step may be added where a decision is made as to whether or not the enter switch has been pushed by a user, so if “YES” then enter, but if “NO” then control processing moves back to Step S1.

In Step S12, a decision is made as to whether or not the setting of a different parameter is requested and if “YES” then control processing moves back to Step S1, but if “NO” then end.

As described above, with the present embodiment, the parameter is stepped at a rate depending on the pressure-sensing value and a matching “click” sensation is generated, so the user interface can be improved.

FIG. 5 is a perspective view showing the controller 200 connected to entertainment system 500. The controller 200 is removably connected to the entertainment system 500, and the entertainment system 500 is connected to television monitor 408.

The entertainment system 500 reads the program for a computer game from recording media upon which that program is recorded and by executing the program, displays characters on the television monitor 408. The entertainment system 500 has various built-in functions for DVD (Digital Versatile Disc) playback, CDDA (compact disc digital audio) playback and the like. The signals from the controller 200 are also processed as one of the aforementioned control functions within the entertainment system 500, and the content thereof may be reflected in the movement of characters and the like, on the television monitor 408.

While this depends also on the content of the computer game program, controller 200 may be allocated functions for moving the characters display on the television monitor 408 in the directions up, down, left or right.

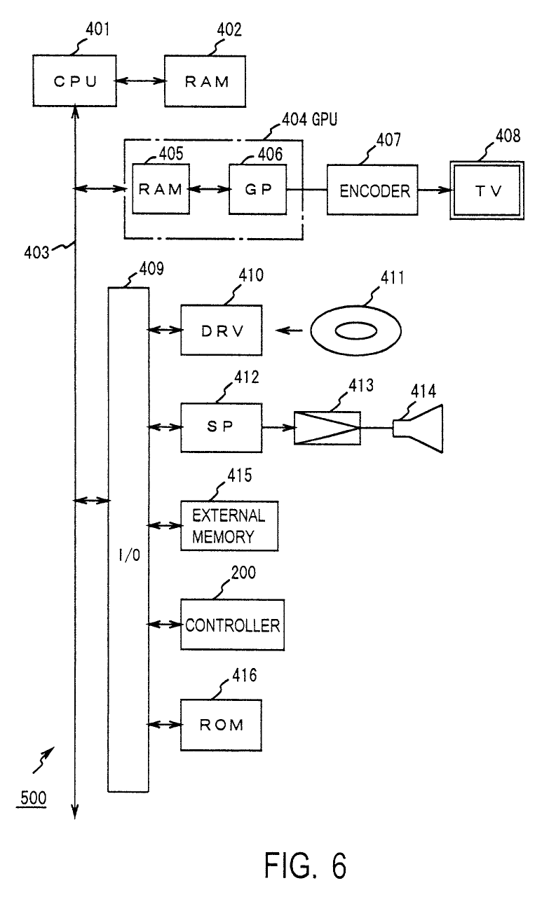

With reference to FIG. 6, here follows a description of the interior of the entertainment system 500 shown in FIG. 5. FIG. 6 is a block diagram of the entertainment system 500.

A CPU 401 is connected to RAM 402 and a bus 403, respectively. Connected to bus 403 are a graphics processor unit (GPU) 404 and an input/output processor (I/O) 409, respectively. The GPU 404 is connected via an encoder 407 for converting a digital RGB signal or the like into the NTSC standard television format, for example, to a television monitor (TV) 408 as a peripheral.

Connected to the I/O 409 are a driver (DRV) 410 used for the playback and decoding of data recorded upon an optical disc 411, a sound processor (SP) 412, an external memory 415 consisting of flash memory, controller 200 and a ROM 416 which records the operating system and the like. The SP 412 is connected via an amplifier 413 to a speaker 414 as a peripheral.

Here, the external memory 415 may be a card-type memory consisting of a CPU or a gate array and flash memory, which is removably connected via a connector 511 to the entertainment system 500 shown in FIG. 5. The controller 200 is configured such that, when a plurality of buttons provided thereupon are pushed, it gives instructions to the entertainment system 500. In addition, the driver 410 is provided with a decoder for decoding images encoded based upon the MPEG standard.

The description will be made now as to how the images will be displayed on the television monitor 408 based on the operation of controller 200. It is assumed that data for objects consisting of polygon vertex data, texture data and the like recorded on the optical disc 411 is read by the driver 410 and stored in the RAM 402 of the CPU 401.

When instructions from the player via controller 200 are provided as an input to the entertainment system 500, the CPU 401 calculates the three-dimensional position and orientation of objects with respect to the point of view based on these instructions. Thereby, the polygon vertex data for objects defined by X, Y, Z coordinate values are modified variously. The modified polygon vertex data is subjected to perspective conversion processing and converted into two-dimensional coordinate data.

The regions specified by two-dimensional coordinates are so-called polygons. The converted coordinate data, Z data and texture data are supplied to the GPU 404. Based on this converted coordinate data, Z data and texture data, the GPU 404 performs the drawing process by writing texture data sequentially into the RAM 405. One frame of image data upon which the drawing process is completed, is encoded by the encoder 407 and then supplied to the television monitor 408 and displayed on its screen as an image.

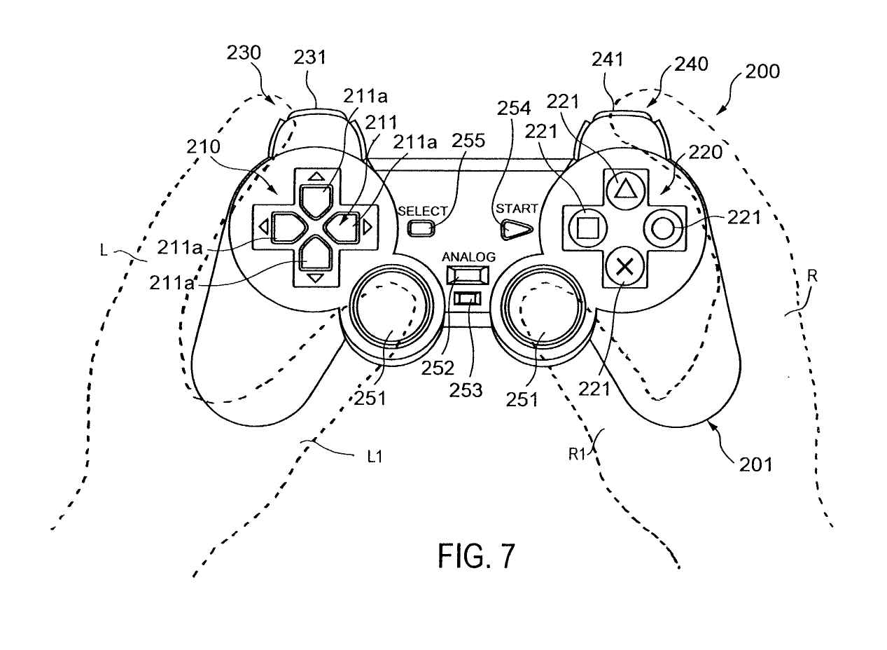

FIG. 7 is a top view of controller 200. The controller 200 consists of a unit body 201 on the top surface of which are provided first and second control parts 210 and 220, and on the side surface of which are provided third and fourth control parts 230 and 240 of the controller 200.

The first control part 210 of the controller is provided with a cruciform control unit 211 used for pushing control, and the individual control keys 211a extending in each of the four directions of the control unit 211 form a control element. The first control part 210 is the control part for providing movement to the characters displayed on the screen of the television receiver, and has the functions for moving the characters in the up, down, left and right directions by pressing the individual control keys 211a of the cruciform control unit 211.

The second control part 220 is provided with four cylindrical control buttons 221 (control elements) for pushing control. The individual control buttons 221 have identifying marks such as “◯” (circle), “×” (cross), “Δ” (triangle) and “□” (quadrangle) on their tops, in order to easily identify the individual control buttons 221. The functions of the second control part 220 are set by the game program recorded upon the optical disc 411, and the individual control buttons 221 may be allocated functions that change the state of the game characters, for example. For example, the control buttons 221 may be allocated functions for moving the left arm, right arm, left leg and right leg of the character.

The third and fourth control parts 230 and 240 of the controller have nearly the same structure, and both are provided with two control buttons 231 and 241 (control elements) for pushing control, arranged above and below. The functions of these third and fourth control parts 230 and 240 are also set by the game program recorded upon the optical disc, and may be allocated functions for making the game characters do special actions, for example.

Moreover, two joy sticks 251 for performing analog operation are provided upon the unit body 201 shown in FIG. 7. The joy sticks 251 can be switched and used instead of the first and second control parts 210 and 220 described above. This switching is performed by means of an analog selection switch 252 provided upon the unit body 201. When the joy sticks 251 are selected, a display lamp 253 provided on the unit body 201 lights, indicating the state wherein the joy sticks 251 are selected.

It is to be noted that on unit body 201 there are also provided a start switch 254 for starting the game and a select switch 255 for selecting the degree of difficulty or the like at the start of a game, and the like.

In FIG. 7, as indicated by broken lines, the controller 200 is held by the left hand L and the right hand R of a user and is operated by the other fingers, and in particular the user's thumbs L1 and R1 are able to operate most of the buttons on the top surface.

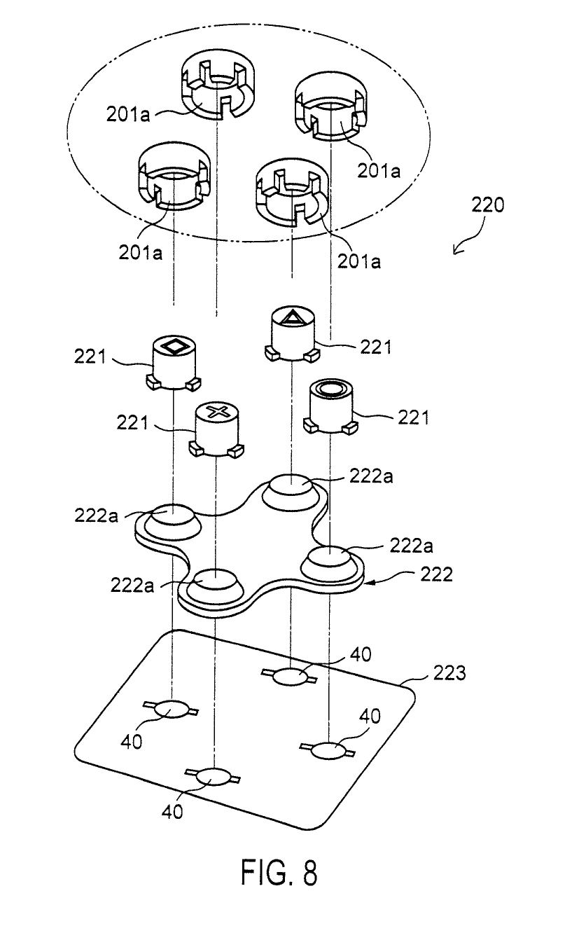

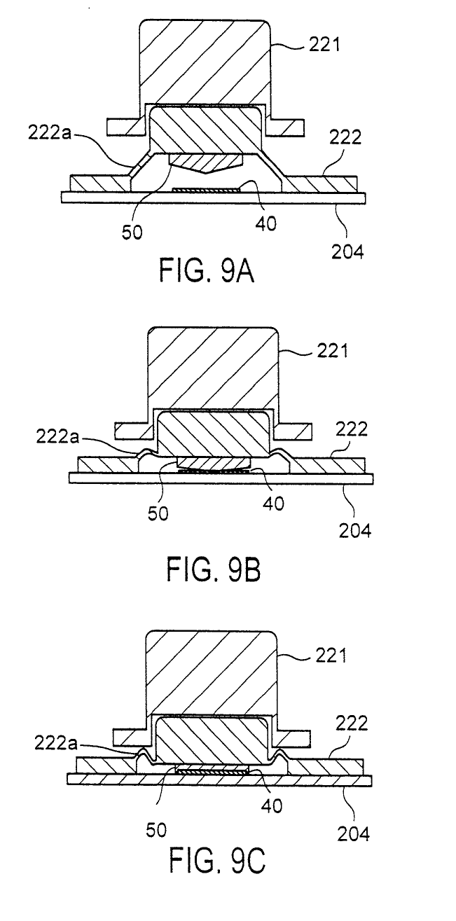

FIG. 8 and FIGS. 9A-9C are, respectively, an exploded respective view and cross-sectional views showing the second control part of the controller.

As shown in FIG. 8, the second control part 220 consists of four control buttons 221 which serve as the control elements, an elastic body 222, and a sheet member 223 provided with resistors 40. The individual control buttons 221 are inserted from behind through insertion holes 201 a formed on the upper surface of the unit body 201. The control buttons 221 inserted into the insertion holes 201a are able to move freely in the axial direction.

The elastic body 222 is made of insulating rubber or the like and has elastic areas 222a which protrude upward, and the lower ends of the control buttons 221 are supported upon the upper walls of the elastic areas 222a. When the control buttons 221 are pressed, the inclined-surface portions of these elastic areas 222a flex so that the upper walls move together with the control buttons 221. On the other hand, when the pushing pressure on the control buttons 221 is released, the flexed inclined-surface portions of elastic areas 222a elastically return to their original shape, pushing up the control buttons 221. The elastic body 222 functions as a spring means whereby control buttons 221 which had been pushed in by a pushing action are returned to their original positions. As shown in FIGS. 9A-9C, conducting members 50 are attached to the rear surface of the elastic body 222.

The sheet member 223 consists of a membrane or other thin sheet material which has flexibility and insulating properties. Resistors 40 are provided in appropriate locations on this sheet member 223 and these resistors 40 and conducting member 50 are each disposed such that they face one of the control buttons 221 via the elastic body 222. The resistors 40 and conducting members 50 form pressure-sensitive devices. These pressure-sensitive devices consisting of resistors 40 and conducting members 50 have resistance values that vary depending on the pushing pressure received form the control buttons 221.

To describe this in more detail, as shown in FIGS. 9A-9C, the second control part 220 is provided with control buttons 221 as control elements, an elastic body 222, conducting members 50 and resistors 40. Each conducting member 50 may be made of conductive rubber which has elasticity, for example, and has a conical shape with its center as a vertex. The conducting members 50 are adhered to the inside of the top surface of the elastic areas 222a formed in the elastic body 222.

In addition, the resistors 40 may be provided on an internal board 204, for example, opposite the conducting members 50, so that the conducting members 50 come into contact with resistors 40 together with the pushing action of the control buttons 221. The conducting member 50 deforms, depending on the pushing force on the control button 221 (namely the contact pressure with the resistor 40), so as shown in FIGS. 9B and 9C, the surface area in contact with the resistor 40 varies depending on the pressure. To wit, when the pressing force on the control button 221 is weak, as shown in FIG. 9B, only the area near the conical tip of the conducting member 50 is in contact. As the pressing force on the control button 221 becomes stronger, the tip of the conducting member 50 deforms gradually so the surface area in contact expands.

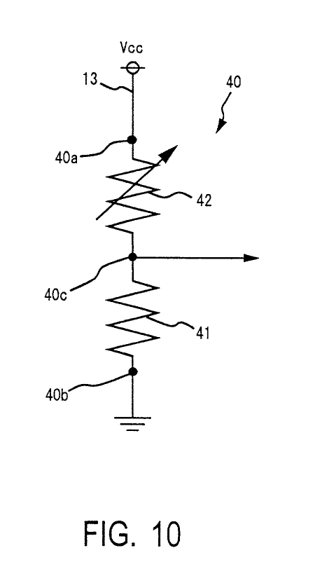

FIG. 10 is a diagram showing an equivalent circuit for a pressure-sensitive device consisting of a resistor 40 and conducting member 50. As shown in this diagram, the pressure-sensitive device is inserted in series in a power supply line 13, where the voltage V_{CC} is applied between the electrodes 40a and 40b. As shown in this diagram, the pressure-sensitive device is divided into a variable resistor 42 that has the relatively small resistance value of the conducting member 50, and a fixed resistor 41 that has the relatively large resistance value of the resistor 40. Among these, the portion of the variable resistor 42 is equivalent to the portion of resistance in the contact between the resistor 40 and the conducting member 50, so the resistance value of the pressure-sensitive device varies depending on the surface area of contact with the conducting member 50.

When the conducting member 50 comes into contact with the resistor 40, in the portion of contact, the conducting member 50 becomes a bridge instead of the resistor 40 and a current flows, so the resistance value becomes smaller in the portion of contact. Therefore, the greater the surface area of contact between the resistor 40 and conducting member 50, the lower the resistance value of the pressure-sensitive device becomes. In this manner, the entire pressure-sensitive device can be understood to be a variable resistor. It is to be noted that FIGS. 9A-9C show only the contact portion between the conducting member 50 and resistor 40 which forms the variable resistor 42 of FIG. 10, but the fixed resistor of FIG. 10 is omitted form FIGS. 9A-9C.

In the preferred embodiment, an output terminal is provided near the boundary between variable resistor 42 and fixed resistor 41, namely near the intermediate point of the resistors 40, and thus a voltage stepped down from the applied voltage Vcc by the amount the variable resistance is extracted as an analog signal corresponding to the pushing pressure by the user on the control button 221.

First, since a voltage is applied to the resistor 40 when the power is turned on, even if the control button 221 is not pressed, a fixed analog signal (voltage) Vₘᵢₙ is provided as the output from the output terminal 40c. Next, even if the control button 221 is pressed, the resistance value of this resistor 40 does not change until the conducting member 50 contacts the resistor 40, so the output from the resistor 40 remains unchanged at Vₘᵢₙ. If the control button 221 is pushed further and the conducting member 50 comes into contact with the resistor 40, the surface area of contact between the conducting member 50 and the resistor 40 increases in response to the pushing pressure on the control button 221, and thus the resistance of the resistor 40 is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed.

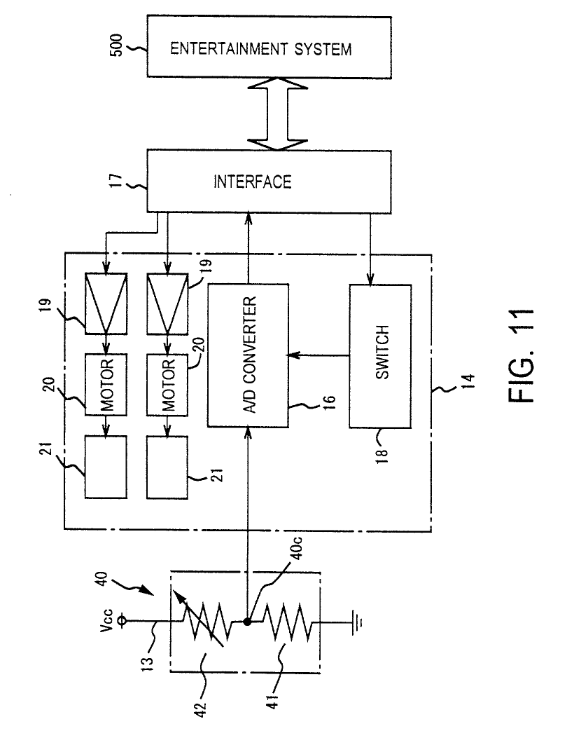

FIG. 11 is a block diagram showing the main parts of the controller 200.

An MPU 14 mounted on the internal board of the controller 200 is provided with a switch 18, an A/D converter 16 and two vibration generation systems. The analog signal (voltage) output from the output terminal 40c of the resistor 40 is provided as the input to the A/D converter 16 and is converted to a digital signal.

The digital signal output from the A/D converter 16 is sent via an interface 17 provided upon the internal board of the controller 200 to the entertainment system 500 and the actions of game characters and the like are executed based on this digital signal.

Changes in the level of the analog signal output from the output terminal 40c of the resistor 40 correspond to changes in the pushing pressure received form the control button 221 (control element) as described above. Therefore, the digital signal outputted from the A/D converter 16 corresponds to the pushing pressure on the control button 221 (control element) from the user. If the actions of the game characters and the like are controlled based on the digital signal that has such a relationship with the pushing pressure from the user, it is possible to achieve smoother and more analog-like action than with control based on a binary digital signal based only on zeroes and ones.

The configuration is such that the switch 18 is controlled by a control signal sent from the entertainment system 500 based on a game program recorded on an optical disc 411. When a game program recorded on optical disc is executed by the entertainment system 500, depending on the content of the game program, a control signal is provided as output to specify whether the A/D converter 16 is to function as a means of providing output of a multi-valued analog signal, or as a means of providing a binary digital signal. Based on this control signal, the switch 18 is switched to select the function of the A/D converter 16.

The MPU 14 includes two vibration generation systems; each of the two vibration generation systems consists of a driver 19 which has a D/A converter that takes drive signals supplied from the entertainment system 500 via an interface 17, converts them to analog signals and amplifies them, a motor 20 driven by the output thereof, and an eccentric member 21 attached to the drive shaft of the motor 20. The eccentric member 21 is of a different size. This is intended to generate vibrations by its rotation. The vibration generation systems are to be described in detail later.

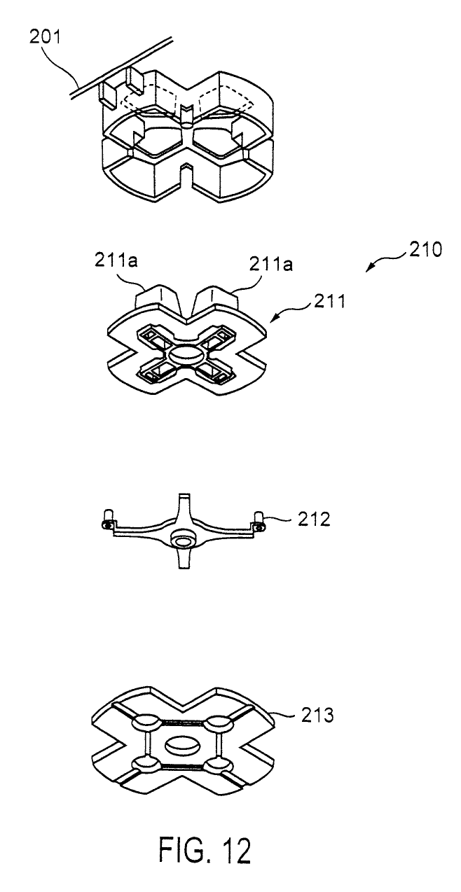

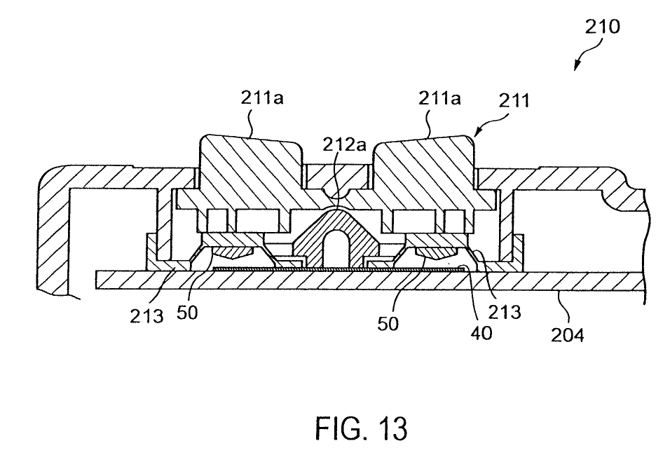

FIGS. 12 and 13 show an embodiment of the configuration of the first control part of the controller.

As shown in FIG. 12, the first control part 210 includes a cruciform control unit 211, a spacer 212 that positions this control unit 211, and an elastic body 213 that elastically supports the control unit 211. Moreover, as shown in FIG. 13, a conducting member 50 is attached to the rear surface of the elastic body 213, and the configuration is such that resistors 40 are disposed at the positions facing the individual control keys 211a (control elements) of the control unit 211 via the elastic body 213.

The overall structure of the first control part 210 has already been made public knowledge in the publication of unexamined Japanese patent application No. JP-A-H8-163672. The control unit 211, however, uses a hemispherical projection 212a formed in the center of the spacer 212 as a fulcrum, and the individual control keys 211a (control elements) are assembled such that they can push on the resistor 40 side (see FIG. 13).

Conducting members 50 are adhered to the inside of the top surface of the elastic body 213 in positions corresponding to the individual control keys 211a (control elements) of the cruciform control unit 211. In addition, the resistors 40 with a single structure are disposed such that they face the individual conducting members 50.

When the individual control keys 211a which are control elements are pushed, the pushing pressure acts via the elastic body 213 on the pressure-sensitive devices consisting of a conducting member 50 and resistor 40, so that its electrical resistance value varies depending on the magnitude of the pushing pressure.

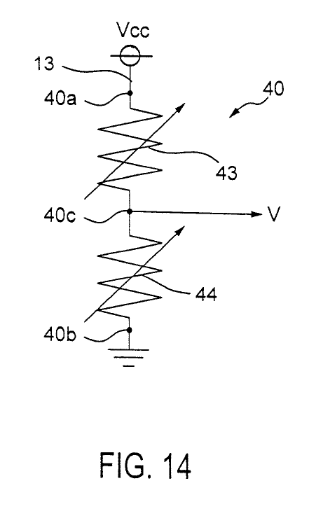

FIG. 14 is a diagram showing the circuit configuration of the resistor. As shown in this diagram, the resistor 40 is inserted in series in a power supply line 13, where a voltage is applied between the electrodes 40a and 40b.

The resistance of this resistor 40 is illustrated schematically, as shown in this diagram; the resistor 40 is divided into first and second variable resistors 43 and 44. Among these, the portion of the first variable resistor 43 is in contact, respectively, with the conducting member 50 that moves together with the control key (up directional key) 211a for moving the character in the up direction, and with the conducting member 50 that moves together with the control key (left directional key) 211a for moving the character in the left direction, so its resistance value varies depending on the surface area in contact with these conducting members 50.

In addition, the portion of the second variable resistor 44 is in contact, respectively, with the conducting member 50 that moves together with the control key (down directional key) 211a for moving the character in the down direction, and with the conducting member 50 that moves together with the control key (right directional Key) 211a for moving the character in the right direction, so its resistance value varies depending on the surface area in contact with these conducting members 50.

Moreover, an output terminal 40c is provided intermediate between the variable resistors 43 and 44, and an analog signal corresponding to the pushing pressure on the individual control keys 211a (control elements) is providing as output from this output terminal 40c.

The output from the output terminal 40c can be calculated from the ratio of the split in resistance value of the first and second variable resistors 43 and 44. For example, if R1 is the resistance value of the first variable resistor 43, R2 is the resistance value of the second variable resistor 44 and V_{CC} is the power supply voltage, then the output voltage V appearing at the output terminal 40c can be expressed by the following equation.

V=V_{CC}×R2/(R1+R2)

Therefore, when the resistance value of the first variable resistor 43 decreases, the output voltage increases, but when the resistance value of the second variable resistor 44 decreases, the output voltage also decreases.

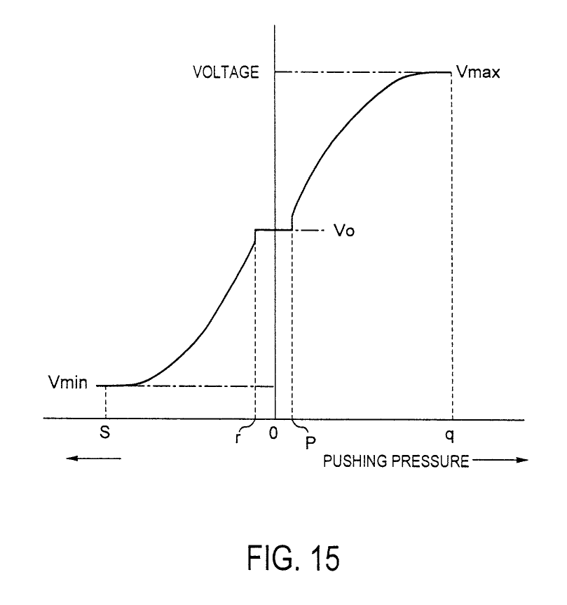

FIG. 15 is a graph showing the characteristics of the analog signal (voltage) outputted from the output terminal of the resistor.

First, since a voltage is applied to the resistor 40 when the power is turned on, even if the individual control keys 211a of the control unit 211 are not pressed, a fixed analog signal (voltage) V₀ is provided as output form the output terminal 40c (at position 0 in the graph).

Next, even if one of the individual control keys 221a is pressed, the resistance value of this resistor 40 does not change until the conducting member 50 contacts the resistor 40, and the output from the resistor 40 remains unchanged at V₀.

Furthermore, if the up-directional key or left-directional key is pushed until the conducting member 50 comes into contact with the first variable resistor 43 portion of the resistor 40 (at position p in the graph), thereafter the surfaced area of contact between the conducting member 50 and the first variable resistor 43 portion increases in response to the pushing pressure on the control key 221a (control elements), and thus the resistance of that portion is reduced so the analog signal (voltage) output from the output terminal 40c of the resistor 40 increases. Furthermore, the analog signal (voltage) output form the output terminal 40c of the resistor 40 reaches the maximum Vₘₐₓ when the conducting member 50 is most deformed (at position q in the graph).

On the other hand, if the down-directional key or right-directional key is pushed until the conducting member 50 comes into contact with the second variable resistor 44 portion of the resistor 40 (at position r in the graph), thereafter the surface area of contact between the conducting member 50 and the second variable resistor 44 portion increases in response to the pushing pressure on the control key 211a (control elements), and thus the resistance of that portion is reduced, and as a result, the analog signal (voltage) output from the output terminal 40c of the resistor 40 decreases. Furthermore, the analog signal (voltage) output form the output terminal 40c of the resistor 40 reaches the minimum Vₘᵢₙ when the conducting member 50 is most deformed (at position s in the graph).

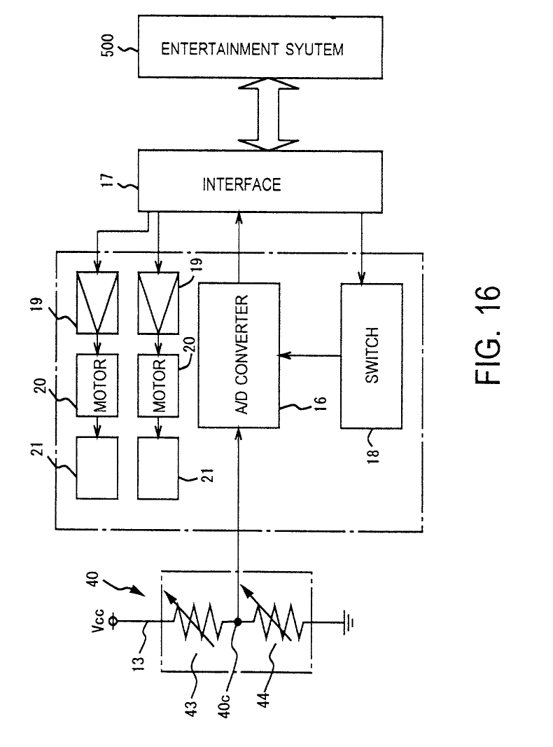

As shown in FIG. 16, the analog signal (voltage) output from the output terminal 40c of the resistor 40 is provided as input to an A/D converter 16 and converted to a digital signal. Note that the function of the A/D converter 16 is shown in FIG. 16 is as described previously based on FIG. 11, so a detailed description shall be omitted here.

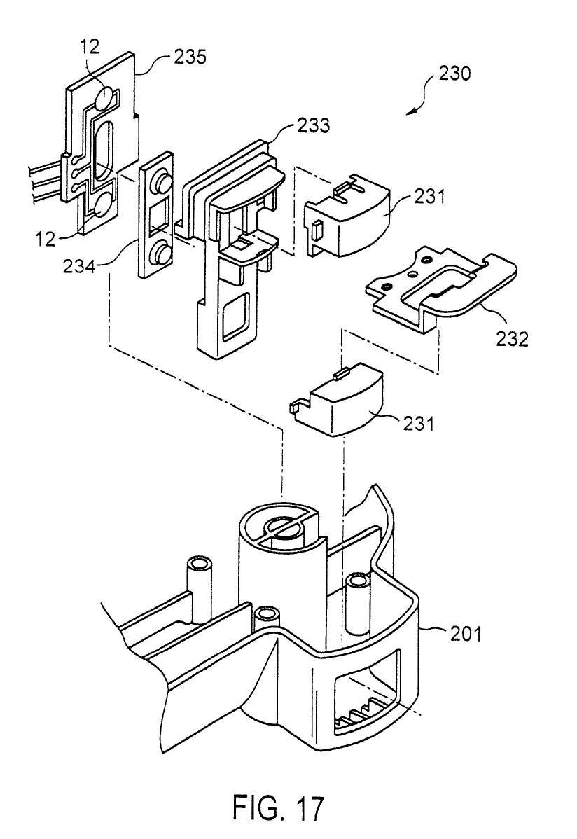

FIG. 17 is an exploded perspective view of the third control part of the controller.

The third control part 230 consists of two control buttons 231, a spacer 232 for positioning these control buttons 231 within the interior of the controller 200, a holder 233 that supports these control buttons 231, an elastic body 234 and an internal board 235, having a structure wherein resistors 40 are attached to appropriate locations upon the internal board 235 and conducting members 50 are attached to the rear surface of the elastic body 234.

The overall structure of the third control part 230 also already has been made public knowledge in the publication of unexamined Japanese patent application No. JP-A-H8-163672, so a detailed description thereof will be omitted. The individual control buttons 231 can be pushed in while being guided by the spacer 232, the pushing pressure when the bottoms 231 are pressed acts via the elastic body 234 on the pressure-sensitive device consisting of a conducting member 50 and resistor 40. The electrical resistance value of the pressure-sensitive device varies depending on the magnitude of the pushing pressure it receives.

It is noted that the fourth control part 240 has the same structure as that of the third control part 230 described above.

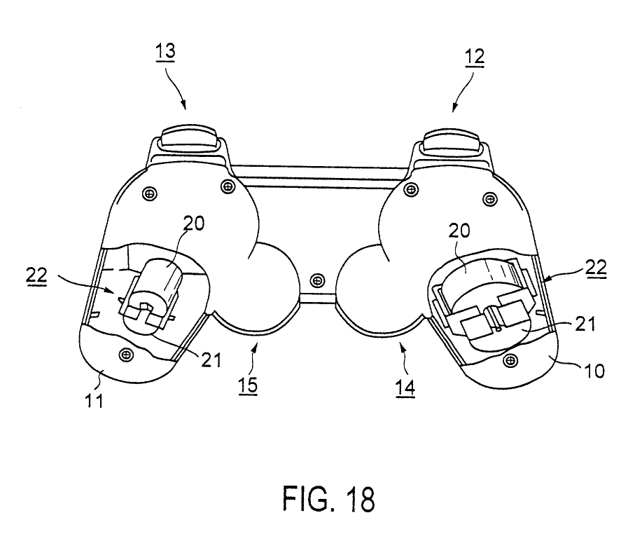

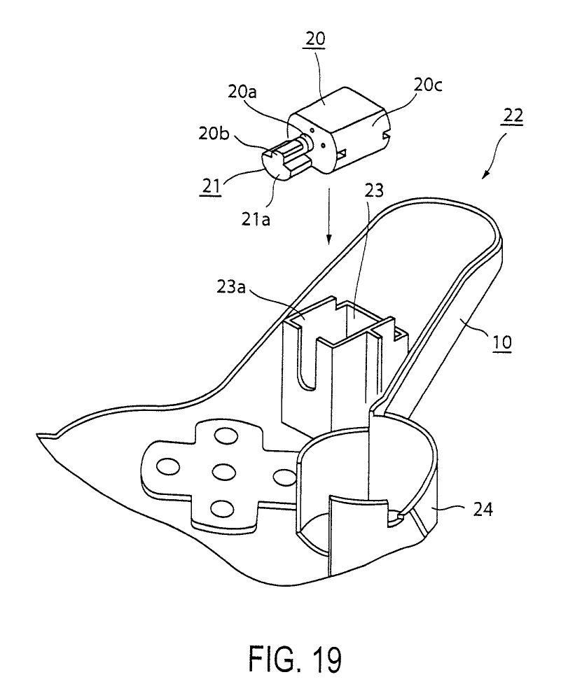

As shown in FIG. 18, the vibration generation system mechanism 22 is disposed on the base sides of the first and second handle parts 10 and 11 which are held by the fingers of the user when the controller 200 is held. As shown in FIG. 19, the vibration generation system mechanism 22 consists of a motor 20 driven by drive signals supplied from the entertainment system 500 and an eccentric member 21 attached to the driveshaft 20a of the motor 20.

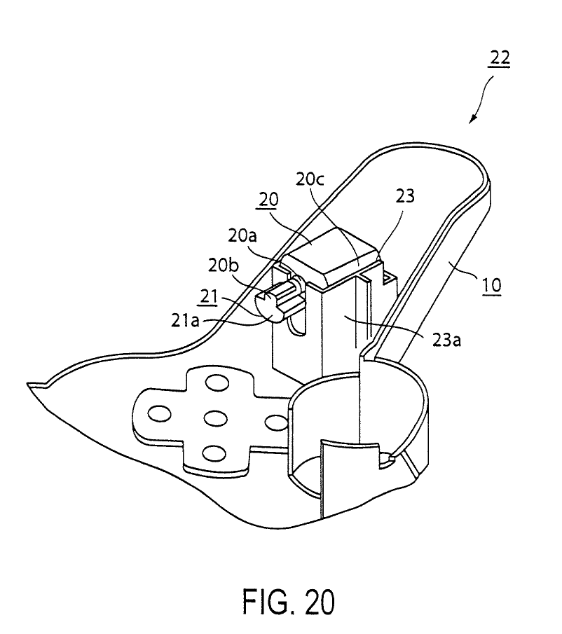

The eccentric member 21 is a metallic member having a large weight, and consists of a semicircular weight 21a which is eccentric with respect to a mating hole 20b which serves as the center of rotation when mated to the drives shaft 20a. As shown in FIG. 20, the motor 20 with the eccentric member 21 attached to its drive shaft 20a is attached to the inside of the first handle part 10, mated to a motor housing 20c in a mating indentation 23 formed as a rectangular tube on the first handle part.

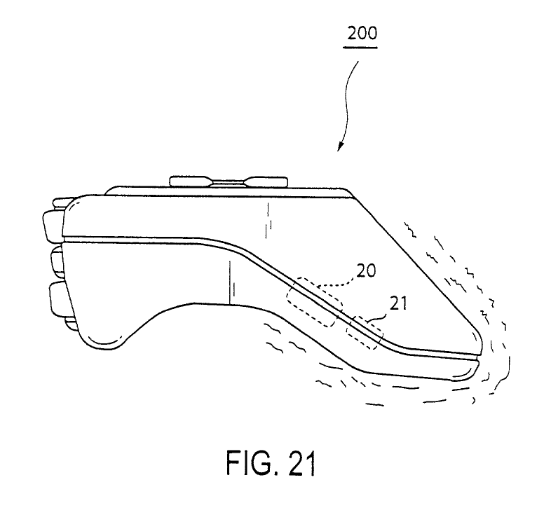

With a vibration generation system mechanism 22 having such a structure, when the motor 20 is driven the eccentric member 21 rotates and the motor 20 vibrates as shown in FIG. 21, and these vibrations are transmitted to the first handle part 10 through the side walls 23a which form the mating indentation 23, and thus the vibration are transmitted to the fingers holding the first handle part 10.

Here, the vibration generation system mechanisms 22 and 22 disposed on the first and second handle parts 10 and 11 are constituted such that the states of generation of vibrations thereof, are different. For example, the vibration generation system mechanisms 22 and 22 have different sizes of motors 20 and different eccentric members 21, so when driven by a fixed driving voltage, by making the speed of rotation different, the speed of rotation of the eccentric members 21 is made different, and the frequency of vibrations can be made to be different.

Within the aforementioned description, FIG. 4 shows a flowchart for incrementing the value of a parameter at a rate depending on the pressure-sensing value, and also, generating with vibration a “click” sensation that matches the incrementing, This program may be supplied either recorded alone upon an optical disc or other recording medium, or recorded upon said recording medium together with the game software as part of the game software.

This program for incrementing the value of a parameter at a rate depending on the pressure-sense value, and also, generating with vibration a “click” sensation that matches the incrementing is run by the entertainment system 500 and executed by its CPU.

Here, the meaning of supplying the program for incrementing the value of a parameter at a rate depending on the pressure-sensing value, and also, generating with vibration a “click” sensation that matches the incrementing recorded individually on a recording medium has the meaning of preparing it in advance as a library for software development. As is common knowledge, at the time of developing software, writing all functions requires an enormous amount of time.

However, if the software functions are divided by the type of function, for example, for moving objects and the like, they can be used commonly by various types of software, so more functions can be included.

To this end, a function such as that described in this preferred embodiment that can be used commonly may be provided to the software manufacturer side as a library program. When general functions like this are supplied as external programs in this manner, it is sufficient for the software manufacturers to write only the essential portions of the software,

While an embodiment was described above, the present invention may also assume the following alternative embodiment. In the described embodiment, the pressure-sensing value as pushed by the user is used as is. However, in order to correct for differences in the body weights of users or differences in how good their reflexes are, it is possible to correct the maximum value of the user pressure-sensing value to the maximum game pressure-sensing value set by the program, and intermediate values may be corrected proportionally and used. This type of correction is performed by preparing a correction table. In addition, the user pressure-sensing value can be corrected based upon a known function. Moreover, the maximum value of the user pressure-sense value rate of change may be corrected to the maximum game pressure-sensing value rate of change set in the program, and intermediate values can be proportionally corrected and used. For more details about this method, refer to the present inventors' Japanese patent application No. 2000-40257 and the corresponding PCT application JP ______ (Applicant's file reference No. SC00097).

Due to this invention, in the case of changing the value of a parameter, for example, the situation of incrementing is not just presented visually by a screen display, so the user interface can be improved further.

Moreover, by means of this invention, it is possible to increase or decrease parameter values depending on the pressure-sense values output when a controller which has a pressure-sensitive device is operated, and also, if desired, it is possible to give the user a “click” sensation corresponding to the unit incrementing/decrementing of the value of the parameter. Thereby, it is possible to transmit to the user the sensation of incrementing a parameter by the pushing of a pressure-sensitive switch, and thus the user interface can be improved even further.

1. A recording medium on which is recorded a computer-readable and executable software program that performs processing by taking as instructions an output from a controller which has pressure-sensitive means for sensing a pushing pressure on the controller by a user, wherein
said software program comprises a processing program that changes settings at a computer at a rate depending on the output of said controller.

2. The recording medium according to claim 1 wherein the changing of settings at a rate depending on the output of said controller is performed by means of a conversion table of rates that depend on the magnitude of the output of said controller.

3. A recording medium on which is recorded a computer-readable and executable software program that performs processing by taking as instructions an output from a controller which has pressure-sensitive means for sensing a pushing pressure of a user on the controller, and vibration means, wherein
said software program comprises a processing program that causes vibrations of said vibration means at a rate depending on the output of said controller.

4. The recording medium according to claim 3, wherein said vibrations are adjusted to be vibrations that give the user holding the controller a “click” sensation.

5. A recording medium on which is recorded a computer-readable and executable software program that performs processing by taking as instructions an output from a controller which has pressure-sensitive means for sensing a pushing pressure of a user on the controller, and vibration means, wherein
said software program comprises a processing program that changes settings at a rate depending on the output of said controller, and also, at least causes vibrations of said vibration means.

6. The recording medium according to claim 5, wherein the changing of settings at a rate depending on the output of said controller is performed by means of a conversion table of rates that depend on a magnitude of the output of the controller.

7. The recording medium according to claim 5, wherein said vibrations are adjusted to be vibrations that give the user holding the controller a “click” sensation.

8. The recording medium according to claim 5, wherein said vibrations are generated with the ratio of generation of “click” sensations adjusted to correspond to a rate depending on said controller.

9. A computer comprising:
a controller which has pressure-sensitive means,
means for sensing a pushing pressure applied by a user to said controller using said pressure-sensitive means and generating a pressure-sensing signal; and
means for changing settings of various parameters of the computer according to said pressure-sensing signal.

10. The computer according to claim 9, said means for changing the settings of various parameters according to said pressure-sensing signal comprises a conversion table of parameter settings that depend on a magnitude of said pressure-sensing signal.

11. A computer comprising:
a controller which has pressure-sensitive means, and vibration means,
means for sensing a pushing pressure of a user on said controller using said pressure-sensitive means to generate a pressure-sensing signal;
means for changing settings of various parameters according to said pressure-sensing signal; and
means for vibrating said vibration means according to said changes in settings of various parameters.

12. The computer according to claim 11, wherein said means of changing the settings of various parameters according to said pressure-sensing signal comprises a conversion table of parameter settings that depend on the magnitude of said pressure-sensing signal.

13. The computer according to claim 11, wherein said vibrations are adjusted to be vibrations that give the user holding the controller a “click” sensation.

14. The computer according to claim 11, wherein said vibrations are generated with the ratio of generation of “click” sensations adjusted to correspond to a rate depending on said pressure-sensing signal.

15. A method of chancing settings of various parameters of electronic equipment, using a computer having a controller which has pressure-sensitive means, the method comprising the steps of:
sensing a pushing pressure applied by a user to said controller by said pressure-sensitive means to generate a pressure-sensing signal; and
changing settings of various parameters according to said pressure-sensing signal.

16. A method of changing settings of various parameters of electronic equipment, using a computer having a controller which has pressure-sensitive means, and vibration means, the method comprising the steps of:
sensing a pushing pressure applied by a user to the controller by said pressure-sensitive means to generate a pressure-sensing signal;
changing the settings of various parameters according to said pressure-sensing signal, and
vibrating said vibration means according to said pressure-sensing signal.

17. The method of using a computer according to claim 16, wherein said vibrations are adjusted to be vibrations that give the user holding the controller a “click” sensation.

18. The method according to claim 16, wherein said vibrations are generated with the ratio of generation of “click” sensations adjusted to correspond to a rate depending on said pressure-sensing signal.

19. A controller connected to a computer and giving instructions to said computer, the controller comprising:
pressure-sensitive means that senses a pushing pressure of a user applied to the controller and generates a pressure-sensing signal as an output applied to said computer; and
vibration means that transmits vibration to the user, and which, when an adjustment of various parameters is performed according to said pressure-sensing signal, vibrates said vibration means corresponding to said adjustment.
